(19) United States
(12) Patent Application Publication
(10) Pub. No.: US 2005/0253957 A1
(43) Pub. Date: Nov. 17, 2005

(54) Mobile electronic apparatus with camera that takes pictures through lens in speaker

(76) Inventors: Stefan Gustavsson, Helsingborg (SE); Henning Schmidt Madsen, Lomma (SE)

Correspondence Address: MYERS BIGEL SIBLEY & SAJOVEC, PO BOX 37428, RALEIGH, NC, 27627, US

(21) Appl. No.: 10/844,845

(22) Filed: May 13, 2004

(51) Int. Cl. H04N 5/238; H04N 5/225

(52) U.S. Cl. 348/363; 348/376

(57) ABSTRACT

A mobile electronic apparatus includes a speaker and a camera device. The speaker includes a diaphragm that is configured to generate audible signals and that defines a light transmissive path therethrough. The camera device takes pictures based on light that passes through the light transmissive path in the diaphragm. The speaker can include a lens that is aligned with the light transmissive path in the diaphragm and that is at least partially transparent to incident light. The lens may be connected to the diaphragm to move therewith. The mobile electronic apparatus can include a control circuit that is configured to move the diaphragm and the lens to variably focus incident light to the camera device.

### FIELD OF THE INVENTION

The present invention generally relates to the camera devices, and more particularly to a mobile electronic devices that include a camera device and a speaker.

### BACKGROUND OF THE INVENTION

Mobile electronic devices have evolved to include increasingly more functionality, while being subject to demands for decreased size. For example, some mobile electronic devices may include a low volume speaker (receiver), microphone, display and keypad that are adjacent to a front side of the housing of the mobile electronic device, and a higher volume speaker that may be used as a hands-free broadcast speaker that is adjacent to a back side of the housing. Some mobile electronic devices also provide a digital camera that can be used to take digital pictures that may be transmitted over a wireless interface. Digital cameras are often adjacent to, and peer through, a back side of the housing of the mobile electronic device. Accordingly, the shape and/or size of the mobile electronic devices may be controlled by the need to locate the speaker(s), microphone, display, keypad, and digital camera adjacent to a housing.

### SUMMARY OF THE INVENTION

Some embodiments of the present invention provide a mobile electronic apparatus that includes a speaker and a camera device. The speaker includes a diaphragm that is configured to generate audible signals and that defines a light transmissive path therethrough. The camera device takes pictures based on light that passes through the light transmissive path in the diaphragm. Accordingly, the speaker may be located between the camera device and a light source that is to be recorded by photo or video.

According to some further embodiments of the present invention, the diaphragm may be circular, and the light transmissive path may be defined in substantially a center of the diaphragm. The diaphragm may be at least partially opaque to light. The speaker may include a lens that is aligned with the light transmissive path in the diaphragm and that is at least partially transparent to incident light. The lens may substantially aligned with a center of the diaphragm. The lens may direct and/or focus incident light to the camera device.

In still some further embodiments of the present invention, the lens may be connected to the diaphragm to move therewith. The mobile electronic apparatus may include a control circuit that is configured to move the diaphragm and the lens to variably focus incident light to the camera device. The camera device may generate a focus signal that is indicative of whether light received by the camera device is in-focus, and the control circuit may move the diaphragm and the lens to vary the focus of incident light to the camera device based on the focus signal from the camera device. The control circuit may generate a control signal, and the speaker may include a voice coil that is configured to move the diaphragm and the lens based on the control signal. The control circuit may generate a substantially direct-current control signal to move the diaphragm and the lens to vary the focus of incident light for the camera device, and may generate a substantially alternating-current control signal to vibrate the diaphragm and generate audible signals.

In some other further embodiments of the present invention, the mobile electronic apparatus may include a housing, a receiver, a display and a microphone. The receiver may be configured to generate lower volume audible signals than the speaker. The housing may have a first surface and an opposing second surface. The receiver may be configured to generate audible signals. The receiver, the display, and the microphone may be adjacent to the first surface of the housing. The speaker may be adjacent to the second surface of the housing. The camera device may be located further from the second surface of the housing than the speaker because it can receive light through the speaker.

In some other further embodiments of the present invention, the mobile electronic apparatus may include a camera phone circuit that transmits pictures from the camera device across any kind of interface, and that generates an audio signal from communications signals received. The speaker may generate audible signals based on the audio signals from the camera phone circuit.

In some other embodiments of the present invention, a mobile electronic apparatus can include a speaker, a camera device, and a control circuit. The speaker includes a diaphragm that defines a light transmissive path therethrough, and a voice coil that is configured to move the diaphragm and the lens based on a control signal. The camera device is configured to take pictures based on light that passes through the light transmissive path in the diaphragm. The control circuit is configured to selectively operate in a camera mode and in an audio mode. In the camera mode, the control circuit is configured to generate a substantially direct-current control signal to move the diaphragm and the lens to vary the focus of incident light for the camera device. In the audio mode, the control circuit is configured to generate a substantially alternating-current control signal to vibrate the diaphragm and generate audible signals.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram of a mobile electronics apparatus in accordance with various embodiments of the present invention; and

FIG. 2 is a block diagram of a mobile electronics apparatus in accordance with some other embodiments of the present invention.

### DETAILED DESCRIPTION OF THE INVENTION

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

It also will be understood that, as used herein, the term “comprising” or “comprises” is open-ended, and includes one or more stated elements, steps and/or functions without precluding one or more unstated elements, steps and/or functions. As used herein the term “and/or” includes any and all combinations of one or more of the associated listed items. It will also be understood that when an element is referred to as being “connected” to another element, it can be directly connected to the other element or intervening elements may be present. In contrast, when an element is referred to as being “directly connected” to another element, there are no intervening elements present. It will also be understood that the sizes and relative orientations of the illustrated elements are not shown to scale, and in some instances they have been exaggerated for purposes of explanation.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

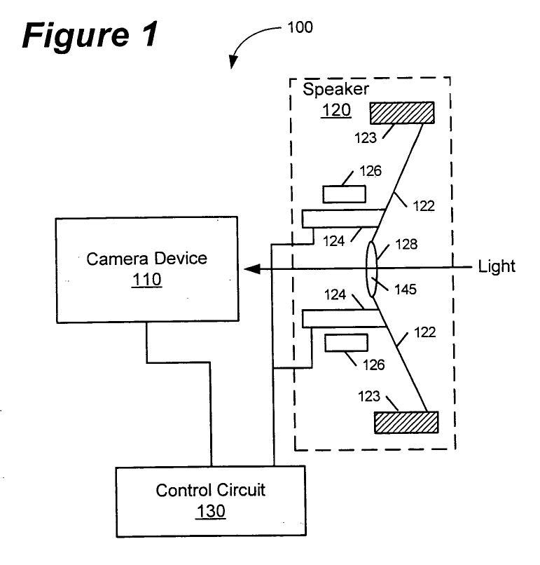

FIG. 1 shows an exemplary block diagram of a mobile electronics device 100 that includes a camera device 110 that takes pictures through a speaker 120 (a cross-section view of which is illustratred), in accordance with some embodiments of the present invention. The camera device 110 may be a digital camera that records still images and/or video images based on the light that passes through the speaker 120. Accordingly, the term “pictures” as used herein includes recording still images and/or video images. The speaker 120 includes a diaphragm 122 that can be vibrated to generate audible signals. For example, the diaphragm 122 may be vibrated in a conventional manner by connecting it to a voice coil 124 that is energized to cause it to move relative to a magnet 126 and to a speaker mount 123.

A light transmissive path is defined through the diaphragm 122. The diagraph 122 may be at least partially opaque to light, and the light transmissive path may be defined by a light transparent material 145 in the diaphragm 122 that allows light to pass through to the camera device 110. It will be understood that the light transmissive path may be defined by an at least partially transparent portion of the diaphragm 122 without departing from the scope of the present invention. The diaphragm 122 may be circular with a conical shape. The light transmissive path may be defined in substantially a center of the diaphragm 122. However, it is to be understood that the light transmissive path may be defined through any portion of the diaphragm 122 without departing from the scope of the present invention.

The speaker may include a lens 128 that is aligned with the light transmissive path through the diaphragm 122 and that is at least partially transparent to incident light. For example, the lens may be substantially aligned with a center of the diaphragm 122. The lens 128 can direct incident light to the camera device 110 and may be used to focus the light on the camera device 110. For example, the lens 128 may include one or more light focusing elements that may be used to focus and/or magnify light that is directed to the camera device 110. The lens 128 can be connected to the diaphragm 122 to move with it. Accordingly, the diaphragm 122 and the lens 128 may be moved relative to the camera device 110 to vary the focus of incident light to the camera device 110. Such variable focus may be used to provide in-focus light to the camera device 110 at a fixed magnification and/or to vary magnification of the light that is provided to the camera device 110.

The mobile electronics apparatus 100 can include a control circuit 130 that generates a control signal that energizes the voice coil 124 to move the diaphragm 122 and the lens 128, and thereby vary the focus of light to the camera device 110. The control circuit 130 may generate a substantially direct-current control signal to move the diaphragm 122 and lens 128 when focusing light on the camera device 110. The control circuit 130 may be calibrated so that the control signal moves the lens 128 a known distance relative to the camera device 110. Alternatively, or additionally, the camera device 110 may generate a focus signal that is indicative of whether the light that it receives is in-focus. The control circuit 130 may move the diaphragm 122 and the lens 128 to vary the focus of light to the camera device 110 based on the focus signal, so as to provide an in-focus picture.

The control circuit 130 may selectively operate in a camera mode and/or in an audio mode. In the camera mode, the control circuit 130 may be configured to move the lens 128 a known or expected distance and hold the lens 128 at that location to focus light on the camera device 110 using, for example, a substantially direct-current control signal. In the audio mode, the control circuit 130 may be configured to vibrate the diaphragm 122 to generate a desired audible signal using an alternating-current control signal. As used herein, an “alternating-current” can have any non-direct-current waveform including periodic and/or aperiodic waveforms. The process of generating audio signals is known to those having skill in the art and therefore, will not be discussed further herein.

As shown in FIG. 1, the speaker 120 may be located between the camera device 110 and a light source that is to be recorded by photo or video. Accordingly, the speaker 120 may be located adjacent to and facing a housing of the mobile electronic device 100 so as to, for example, avoid distortion of audible signals therefrom. Thus, according to embodiments of the present invention, the camera device 110 may be located further from the housing because it can receive light through the speaker 120. Mobile electronic apparatus may thereby be designed differently and/or more compact because it is not necessary to locate both a camera device and speaker adjacent to its housing.

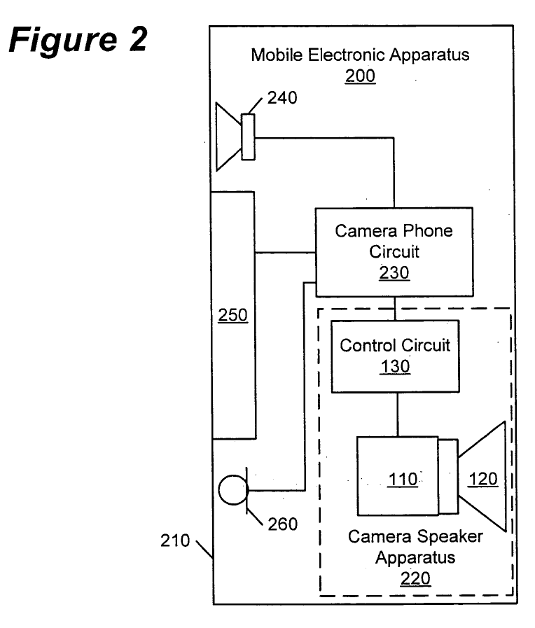

The present invention may also be embodied in other types of mobile electronic apparatus that include a camera and a speaker without departing from the scope of the present invention. For example, the mobile electronic apparatus may include a RF radio and a camera, and/or it may include a mobile communication terminal such as a satellite or cellular radiotelephone and a camera device. FIG. 2 illustrates a mobile electronic apparatus 200 that provides a combined cellular communication terminal with a camera according to various embodiments of the present invention. The mobile electronic apparatus 200 may include a camera speaker apparatus 220, a camera phone circuit 230, a receiver 240, a display 250, and a microphone 260, each of which are enclosed within a housing 210.

The exemplary camera speaker apparatus 220 includes the camera device 110, the speaker 120, and the control circuit 130 described above with reference to FIG. 1. The camera phone circuit 230 may be configured to transmit pictures from the camera speaker apparatus 220 over a wireless interface, such as a cellular RF interface, and may display the pictures on the display 250. The camera phone circuit 230 may also be configured to generate an audio signal from communication signals that are received over a wireless interface. The transmission of digital pictures and generation of audio signals from received communication signal may be carried out by the camera phone circuit 230 in a conventional manner. The audio signal can be provided to the speaker 120 and/or to the receiver 240 to generate audible signals therefrom. The speaker 120 may be a broadcast speaker that is capable of generating a higher volume audible signal than the receiver 240. For example, the speaker 120 may be used as a broadcast speaker in a speaker-phone for more remote monitoring of audio signals than from the receiver 240. The camera phone circuit 230 may also communicate audio signals from the microphone 260 over a wireless interface.

The receiver 240, speaker 120, display 250, and microphone 260 may be located adjacent to the housing 210 to avoid distortion of audio signals and viewing of the display 250. The receiver 240 and microphone 260 may be located adjacent to a common side of the housing for convenience of operation by a user, and the speaker 120 may be located adjacent to an opposite side of the housing from the receiver and microphone 260. Because light can pass through the speaker 120 to the camera device 110, the speaker 120 may be located between an adjacent portion of the housing 210 and the camera device 110. Consequently, it may not be necessary to locate the camera device 110 adjacent to a side of the housing 210, which may allow the mobile electronic apparatus 200 to be designed differently and/or more compact relative to a conventional camera speaker apparatus.

Many variations and modifications can be made to the preferred embodiments without substantially departing from the principles of the present invention. All such variations and modifications are intended to be included herein within the scope of the present invention, as set forth in the following claims.

1. A mobile electronic apparatus comprising:
a speaker comprising a diaphragm that is configured to generate audible signals and that defines a light transmissive path therethrough; and
a camera device that is configured to take pictures based on light that passes through the light transmissive path in the diaphragm.

2. The mobile electronic apparatus of claim 1, wherein the light transmissive path is defined in substantially a center of the diaphragm.

3. The mobile electronic apparatus of claim 2, wherein the diaphragm is circular.

4. The mobile electronic apparatus of claim 1, wherein the diaphragm is at least partially opaque to light.

5. The mobile electronic apparatus of claim 1, wherein the speaker further comprises a lens that is aligned with the light transmissive path in the diaphragm and that is at least partially transparent to incident light.

6. The mobile electronic apparatus of claim 5, wherein the lens is substantially aligned with a center of the diaphragm.

7. The mobile electronic apparatus of claim 5, wherein the lens is configured to direct incident light to the camera device.

8. The mobile electronic apparatus of claim 7, wherein the lens is configured to focus incident light to the camera device.

9. The mobile electronic apparatus of claim 8, wherein the lens is connected to the diaphragm to move therewith.

10. The mobile electronic apparatus of claim 9, further comprising a control circuit that is configured to move the diaphragm and the lens to variably focus incident light to the camera device.

11. The mobile electronic apparatus of claim 10, wherein:
the camera device is configured to generate a focus signal that is indicative of whether light received by the camera device is in-focus; and
the control circuit is configured to move the diaphragm and the lens to vary the focus of incident light to the camera device based on the focus signal from the camera device.

12. The mobile electronic apparatus of claim 10, wherein:
the control circuit is configured to generate a control signal; and
the speaker comprises a voice coil that is configured to move the diaphragm and the lens based on the control signal.

13. The mobile electronic apparatus of claim 12, wherein the control circuit is configured to generate a substantially direct-current control signal to move the diaphragm and the lens to vary the focus of incident light for the camera device.

14. The mobile electronic apparatus of claim 12, wherein the control circuit is configured to generate a substantially alternating-current control signal to vibrate the diaphragm and generate audible signals.

15. The mobile electronic apparatus of claim 1, further comprising:
a housing having a first surface and an opposing second surface;
a receiver that is configured to generate audible signals;
a display; and
a microphone, wherein the receiver, the display, and the microphone are adjacent to the first surface of the housing, and wherein the speaker is adjacent to the second surface of the housing.

16. The mobile electronic apparatus of claim 15, wherein the receiver is configured to generate lower volume audible signals than the speaker.

17. The mobile electronic apparatus of claim 1, further comprising:
a camera phone circuit that is configured to transmit pictures from the camera device across a wireless interface, and is configured to generate an audio signal from communications signals received over a wireless interface, wherein the speaker is configured to generate audible signals based on the audio signals from the camera phone circuit.

18. A mobile electronic apparatus comprising:
a speaker comprising a diaphragm that defines a light transmissive path therethrough, and a voice coil that is configured to move the diaphragm and the lens based on a control signal;
a camera device that is configured to take pictures based on light that passes through the light transmissive path in the diaphragm; and
a control circuit that is configured to selectively operate in a camera mode and in an audio mode, and wherein the control circuit is configured to generate a substantially direct-current control signal to move the diaphragm and the lens to vary the focus of incident light for the camera device in the camera mode, and is configured to generate a substantially alternating-current control signal to vibrate the diaphragm and generate audible signals in the audio mode.
